(19) United States
(12) Patent Application Publication
(10) Pub. No.: US 2025/0125505 A1
(43) Pub. Date: Apr. 17, 2025

(54) ELECTRONIC DEVICE

(71) Applicant: ASUSTeK COMPUTER INC., Taipei City (TW)

(72) Inventors: Hao-Hsuan Lin, Taipei City (TW); Yu-Hsiu Su, Taipei City (TW); Yu-Cheng Shen, Taipei City (TW); Shih-Hsiang Kao, Taipei City (TW); Wan-Ling Wong, Taipei City (TW); Min-Che Kao, Taipei City (TW); Yu-Lung Wu, Taipei City (TW); Yen-Po Liao, Taipei City (TW)

(73) Assignee: ASUSTeK COMPUTER INC., Taipei City (TW)

(21) Appl. No.: 18/800,126

(22) Filed: Aug. 11, 2024

(30) Foreign Application Priority Data
Oct. 16, 2023 (TW) 112139339

(51) Int. Cl. H01M 50/569; H01M 10/42; H01M 50/204; H01M 50/247; H01M 50/296; H01M 50/574; H02J 7/00

(52) U.S. Cl. CPC H01M 50/569; H01M 10/425; H01M 50/204; H01M 50/247; H01M 50/296; H01M 50/574; H01M 2220/30; H02J 7/0036

(57) ABSTRACT

An electronic device includes a battery module, a battery connector and a controller is provided. The battery connector includes a first connector and a second connector. The first connector is installed on the battery module and includes a first metal component and an enable pin. The first metal component is disposed on a housing of the first connector and is coupled to the enable pin. The second connector includes a second metal component, a detection pin and a ground pin. The second metal component is disposed on a housing of the second connector. The detection pin is coupled to the second metal component. The ground pin is coupled to a ground potential and its position corresponds to the position of the enable pin. The controller determines a connection status of the first connector and the second connector according to an external signal on the detection pin.

### CROSS-REFERENCE TO RELATED APPLICATION

This application claims the priority benefit of Taiwan application serial no. 112139339, filed on Oct. 16, 2023. The entirety of the above-mentioned patent application is hereby incorporated by reference herein and made a part of this specification.

### BACKGROUND

### Technical Field

The application relates to an electronic device that can detect the connection status of a battery connector.

### Description of Related Art

In order to pursue environmental protection, reduce electronic waste, and avoid monopoly situations, the European Union has recently voted through a new draft for consumer electronic products, requiring that the internal accessories of all electronic products must be replaceable to extend the life of electronic products. As a result, the chances of replacing internal components of electronic products will be greatly increased. Since the battery module needs to be removed to disconnect the power supply every time before replacing the internal components of electronic products, the chances of users disassembling and assembling the battery module themselves will also increase. If the battery connector is not connected correctly, there may be a risk of the connector being burned, which could lead to serious safety issues.

### SUMMARY

The application provides an electronic device, which includes a battery module, a battery connector and a controller. The battery connector includes a first connector and a second connector. The first connector is installed on the battery module and includes a first metal component and an enable pin. The first metal component is disposed on a housing of the first connector and is coupled to the enable pin via a conductive path. The second connector includes a second metal component, a detection pin and a ground pin. The second metal component is disposed on a housing of the second connector. The detection pin is coupled to the second metal component. The ground pin is coupled to a ground potential and its position corresponds to the position of the enable pin. The controller determines a connection status of the first connector and the second connector according to an external signal on the detection pin.

Based on the above, the electronic device of the application can detect the connection status of the battery connector through the controller. When the battery connector is not connected correctly, a warning notification can be issued to the user so that the user can reassemble it as soon as possible. In this way, the safety of the battery module can be ensured and dangerous safety issues can be avoided.

In order to make the above-mentioned features and advantages of this case more obvious and easier to understand, embodiments are given below and explained in detail with the accompanying drawings.

### BRIEF DESCRIPTION OF THE DRAWINGS

FIG. 1 is a schematic circuit diagram of the electronic device according to an embodiment of the present invention.

FIG. 2 is an example of a notification screen according to an embodiment of the present invention.

FIG. 3 is a flow chart of a connection status detection method according to an embodiment of the present invention.

### DESCRIPTION OF THE EMBODIMENTS

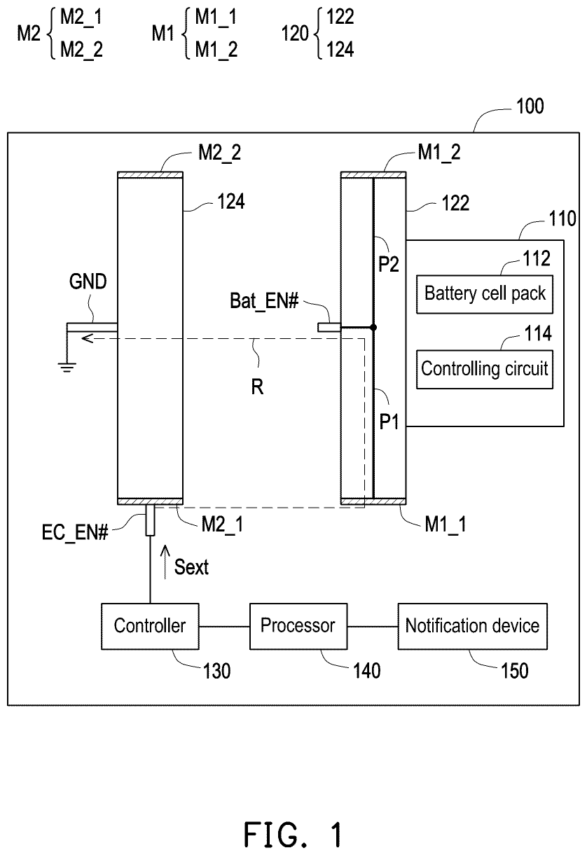

Referring to FIG. 1, an electronic device 100 of the embodiment is, for example, a notebook computer, a mobile phone, a digital camera, a tablet computer and other handheld electronic products. The electronic device 100 includes a battery module 110, a battery connector 120, a controller 130, a processor 140 and a notification device 150.

The battery module 110 is a built-in battery module that can be used to power the electronic device 100. The battery module 110 includes a battery cell pack 112 and a controlling circuit 114. The battery cell pack 112 is, for example, composed of a single or multiple battery cells (battery cell units). The controlling circuit 114 includes, for example, a Battery gauge IC or a Microcontroller, which can calculate the stored power and charge and discharge current of the battery module 110, and control the charge and discharge operations.

The battery connector 120 includes a first connector 122 and a second connector 124. The first connector 122 is, for example, a male connector installed on the battery module 110. The first connector 122 includes a first metal component M1 and an enable pin Bat_EN #. In FIG. 1, the first metal component M1 is a conductor and is divided into a first shell metal component M1_1 and a first shell metal component M1_2. The first shell metal components M1_1, M1_2 are disposed on a shell of the first connector 122 and are coupled to the enable pin Bat_EN # via conductive paths P1 and P2 respectively. The conductive paths P1 and P2 are, for example, made of metal wires, allowing conduction between the first shell metal components M1_1, M1_2 and the enable pin Bat_EN #. The conductive paths P1 and P2 are, for example, disposed inside or outside the first connector 122, but the present invention is not limited thereto.

The second connector 124 is, for example, a female connector disposed on a Printed circuit board (PCB) in the electronic device 100 together with the controller 130 and the processor 140. The second connector 124 includes a second metal component M2, a detection pin EC_EN # and a ground pin GND. In FIG. 1, the second metal component M2 is a conductor and is divided into a second shell metal component M2_1 and a second shell metal component M2_2. The second shell metal component M2_1, M2_2 are disposed on a shell of the second connector 124, and their positions respectively correspond to the positions of the first shell metal components M1_1, M1_2 on the first connector 122. The detection pin EC_EN # is disposed on the side of the second connector 124 and coupled to the second shell metal component M2_1. The ground pin GND is coupled to ground potential (0 volts), and its position corresponds to the position of the enable pin Bat_EN # on the first connector 122.

In details, after the user assembles the battery module 110, when the first connector 122 and the second connector 124 are correctly connected (such as, the upper and lower ends of the first connector 122 and the second connector 124 are tightly coupled so that each pin on the first connector 122 is accurately connected to the pin on the second connector 124), the first shell metal component M1_1 and the second shell metal component M2_1 are in contact with each other, the first shell metal component M1_2 and the second shell metal component M2_2 are in contact with each other, and the enable pin Bat_EN # and the ground pin GND can be accurately connected. At this time, the enable pin Bat_EN # may be pulled down to the ground potential. At the same time, as shown by the dotted circle R in FIG. 1, the detection pin EC_EN # is coupled to the enable pin Bat_EN # via the second shell metal component M2_1, the first shell metal component M1_1 and the conductive path P1. Therefore, the detection pin EC_EN # may also be pulled down to the ground potential.

In addition, the first metal component M1 and the second metal component M2 are buckle structures that are complementary to each other. For example, the first metal component M1 and the second metal component M2 have U-shaped spring pieces and concave spring pieces respectively. When the first connector 122 and the second connector 124 are correctly connected, the first shell metal component M1_1 and the second shell metal component M2_1 are snapped together automatically, the first shell metal component M1_2 and the second shell metal component M2_2 are snapped together automatically, thereby connecting and fixing the first connector 122 and the second connector 124. In this way, when the user assembles the battery module 110, there is no need to manually connect and fix the first connector 122 and the second connector 124. The battery module 110 can be directly assembled in one step, improving the convenience of self-replacement of the battery.

On the other hand, as shown in FIG. 1, in a connecting direction between the enable pin Bat_EN # and the ground pin GND, the structure of the ground pin GND is longer than the structure of the enable pin Bat_EN #. When the first connector 122 and the second connector 124 are not connected correctly (for example, the first connector 122 detaches from the second connector 124 and some or all of the pins on the first connector 122 cannot be accurately connected to the pins on the second connector 124), the enable pin Bat_EN # and the ground pin GND are disconnected through the height difference design on the first connector 122 or the second connector 124. At this time, neither the enable pin Bat_EN #nor the detection pin EC_EN # may be pulled down to the ground potential.

The controller 130 is, for example, an embedded controller (EC) or a Microcontroller. The controller 130 is coupled to the detection pin EC_EN # through the General-purpose input/output (GPIO) pin, and the connection status of the first connector 122 and the second connector 124 can be determined based on an external signal Sext on the detection pin EC_EN #. Specifically, through the above-mentioned structural design of the first connector 122 and the second connector 124, when the external signal Sext is at the ground potential, the controller 130 can determine that the first connector 122 and the second connector 124 are correctly connected. When the external signal Sext is not at the ground potential, the controller 130 may determine that the first connector 122 and the second connector 124 are not correctly connected.

The processor 140 is, for example, Central Processing Unit (CPU), or other programmable general-purpose or special-purpose Microprocessor, Digital Signal Processor (DSP), programmable controller, Application Specific Integrated Circuit (ASIC) or other similar components or a combination of the above components. The processor 140 is coupled to the controller 130 and the notification device 150.

The notification device 150 is, for example, a Liquid Crystal Display (LCD), a display using Light-Emitting Diode (LED), a Field Emission Display (FED) or other types of panels. The notification device 150 can be used to display a notification screen (including a message or window) to deliver messages or any information to the user. However, in another embodiment, the notification device 150 can also be a speaker, which can play sounds to deliver messages to the user, but the present invention is not limited thereto.

When the external signal Sext is at the ground potential and the controller 130 determines that the first connector 122 and the second connector 124 are correctly connected, the controller 130 can communicate with the battery module 110 through a communication protocol. At this time, the controller 130 will not report a connection abnormality. The communication protocol of the embodiment is, for example, System Management Bus (SMBus) or Inter-Integrated Circuit (I2C), but the embodiment is not limited thereto.

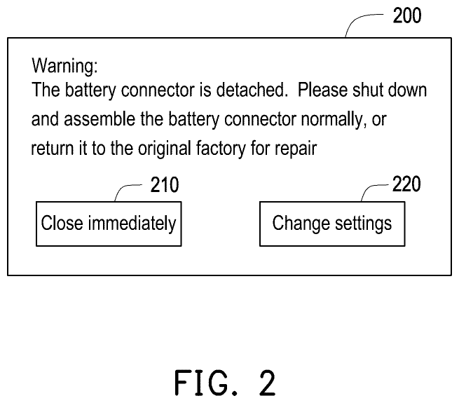

On the contrary, When the external signal Sext is not at the ground potential (for example, at floating or other potential) and the controller 130 determines that the first connector 122 and the second connector 124 are not correctly connected, the controller 130 can report a connection abnormality to the application program (upper-layer application program) executed by the processor 140, so as to issue a warning notification 200 to the user after a predetermined time through the notification device 150. For example, FIG. 2 illustrates an example of the warning notification 200. Referring to FIG. 2, the warning notification 200 displays the text “Warning: The battery connector is detached. Please shut down and assemble the battery connector normally, or return it to the original factory for repair” to remind the user of abnormal information such as the battery connector 120 being loose. Moreover, the user can be prevented from misunderstanding that the battery connector 120 is damaged.

As shown in FIG. 2, the warning notification 200 also displays icons 210 and 220 representing “Close immediately” and “Change settings” respectively, for the user to select through input devices such as a mouse and input buttons.

Furthermore, the user can, for example, turn on the hardware detection function of the external signal of the controlling circuit 114 in the battery module 110 through the application program or firmware settings. When a hardware detection function of the external signal is turned on, the controlling circuit 114 can detect the enable pin Bat_EN #. When the enable pin Bat_EN # is not pulled down to the ground potential, the controlling circuit 114 disconnects the charging transistor on the charging path and the discharging transistor on the discharging path of the battery module 110 to disconnect the charging path and the discharging path. In other words, the battery module 110 may provide power only when the first connector 122 and the second connector 124 are correctly connected. If the first connector 122 and the second connector 124 are not connected correctly (for example, abnormal assembly or abnormal detachment occurs), the controlling circuit 114 will actively turn off the power of the battery module 110. In this way, the battery module 110 can remain in a power-off state before being assembled correctly, ensuring its safety and thus avoiding safety issues.

Incidentally, for the convenience of understanding, in the embodiment of FIG. 1, the first metal component M1 on the first connector 122 and the second metal component M2 on the second connector 124 are respectively divided into two shell metal components arranged at different positions for explanation. However, as long as the first connector 122 and the second connector 124 are correctly connected and their shell metal components are configured to contact each other, the present invention does not limit the number of the shell metal components. In addition, the detection pin EC_EN # on the second connector 124 is configured to couple to the second shell metal component M2_1 in the embodiment, but the present invention is not limited thereto. In other embodiments, the detection pin EC_EN # may also be configured to couple to other shell metal components on the second connector 124.

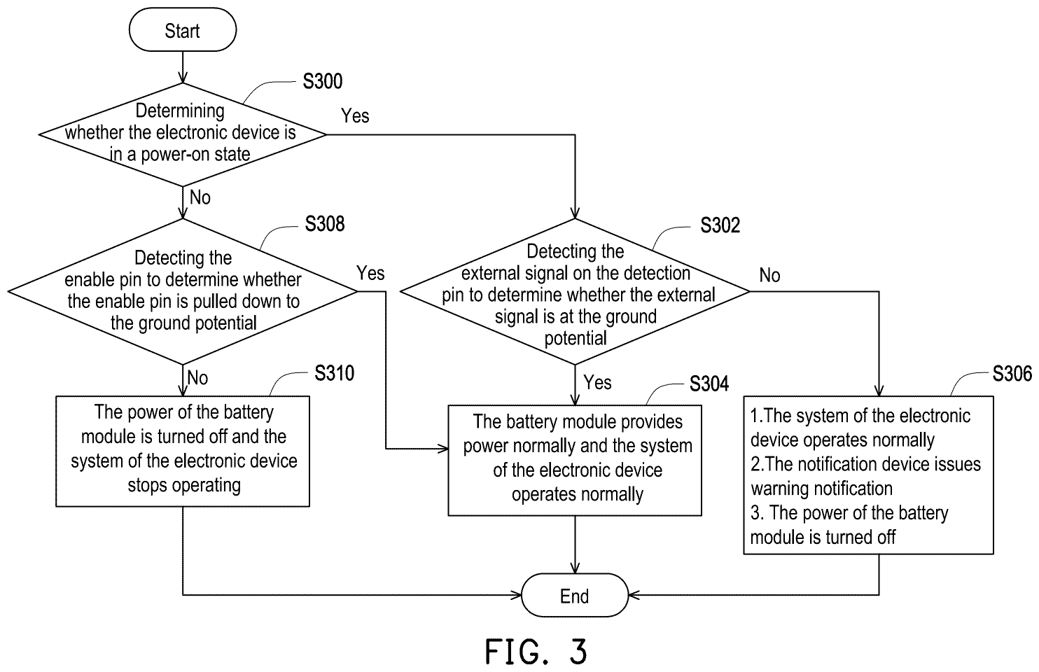

The following examples illustrate the detailed steps of the connection status detection method of the present invention. Referring to FIG. 1 and FIG. 3 at the same time, the connection status detection method of the embodiment can be applied to the electronic device 100 of FIG. 1, and the steps are described as follows:

First, in step S300, the controller 130 determines whether the electronic device 100 is in a power-on state. The power-on state of the embodiment refers to a state in which a power adapter (such as an AC adapter) is inserted into the electronic device 100 to provide power.

When the electronic device 100 is in a power-on state, in step S302, the controller 130 detects the external signal Sext on the detection pin EC_EN # to determine whether the external signal Sext is at the ground potential.

When the external signal Sext is at the ground potential, the controller 130 may determine that the first connector 122 and the second connector 124 are correctly connected. In step S304, the battery module 110 provides power normally, and the system of the electronic device 100 operates normally.

When the external signal Sext is not at the ground potential, the controller 130 may determine that the first connector 122 and the second connector 124 are not correctly connected. In step S306, since the electronic device 100 is in a power-on state, its system can still be powered on and operate normally. However, the application (upper-layer application) executed by the processor 140 may receive a connection abnormality report from the controller 130, and issue a warning notification to the user through the notification device 150. At the same time, the controlling circuit 114 may also turn off the power of the battery module 110 to ensure the safety of the battery module 110.

On the other hand, if the controller 130 determines that the electronic device 100 is not in a power-on state in step S300, the controlling circuit 114 in the battery module 110 detects the enable pin Bat_EN # to determine whether the enable pin Bat_EN # is pulled down to the ground potential in step 308.

If the enable pin Bat_EN # is pulled down to the ground potential, it means that the first connector 122 and the second connector 124 are not connected correctly. In step S304, the battery module 110 provides power normally, and the system of the electronic device 100 operates normally.

If the enable pin Bat_EN # is not pulled down to the ground potential, it means that the first connector 122 and the second connector 124 are not connected correctly. In step S310, the controlling circuit 114 turns off the power of the battery module 110, and the system of the electronic device 100 stops operating.

In summary, the electronic device of the application can detect the connection status of the battery connector through the controller. When the battery connector is not connected correctly, a warning notification can be issued to the user so that the user can reassemble it as soon as possible. At the same time, the power of the battery module may also be automatically turned off. In this way, the safety of the battery module can be ensured and dangerous safety issues can be avoided.

What is claimed is:

1. An electronic device, comprising:
a battery module;
a battery connector, comprising:
a first connector, installed on the battery module and comprises a first metal component and an enable pin, the first metal component is disposed on a housing of the first connector and is coupled to the enable pin via a conductive path; and
a second connector, comprises a second metal component, a detection pin and a ground pin, the second metal component is disposed on a housing of the second connector, the detection pin is coupled to the second metal component, the ground pin is coupled to a ground potential and its position corresponds to the position of the enable pin; and
a controller, coupled to the detection pin, determines a connection status of the first connector and the second connector according to an external signal on the detection pin.

2. The electronic device according to claim 1, wherein when the first connector and the second connector are connected correctly, the first metal component and the second metal component are in contact with each other, the enable pin is connected to the ground pin, the detection pin is coupled to the enable pin via the second metal component, the first metal component and the conductive path.

3. The electronic device according to claim 2, wherein when the first connector and the second connector are not connected correctly, the enable pin and the ground pin are disconnected.

4. The electronic device according to claim 1, wherein the first metal component and the second metal component are buckle structures that are complementary to each other, when the first connector and the second connector are correctly connected, the first metal component snaps together with the second metal component.

5. The electronic device according to claim 1, wherein the detection pin is disposed on one side of the second connector.

6. The electronic device according to claim 1, wherein the battery module comprises a battery cell pack and a controlling circuit,
when a hardware detection function of the external signal is turned on, the controlling circuit detects the enable pin.

7. The electronic device according to claim 6, wherein when the enable pin is not pulled down to the ground potential, the controlling circuit disconnects a charging path and a discharging path of the battery module.

8. The electronic device according to claim 1, further comprises a processor and a notification device, the processor is coupled to the controller and the notification device, when the external signal is not at the ground potential, the controller reports a connection abnormality to an application executed by the processor to issue a warning notification through the notification device.

9. The electronic device according to claim 1, wherein the controller determines whether the electronic device is in a power-on state,
when the electronic device is in the power-on state, the controller detects the external signal on the detection pin.

10. The electronic device according to claim 9, wherein when the electronic device is not in the power-on state, if the enable pin is not pulled down to the ground potential, the electronic device stops operating.
